(19) United States
(12) Patent Application Publication
(10) Pub. No.: US 2026/0188529 A1
(43) Pub. Date: Jul. 2, 2026

(54) ELECTROMAGNETIC RADIATION GENERATION

(71) Applicant: UNITED KINGDOM ATOMIC ENERGY AUTHORITY, Abingdon, Oxfordshire (GB)

(72) Inventors: Ivan V KONOPLEV, Abingdon (GB); Mark HENDERSON, Abingdon (GB)

(73) Assignee: UNITED KINGDOM ATOMIC ENERGY AUTHORITY, Abingdon, Oxfordshire (GB)

(21) Appl. No.: 19/128,719

(22) PCT Filed: Nov. 8, 2023
(86) PCT No.: PCT/GB2023/052915

§ 371 Date: May 9, 2025

(30) Foreign Application Priority Data
Nov. 10, 2022 (GB) 2216778.7

(51) Int. Cl. G21B 1/23; H01J 23/027; H01J 23/065; H01J 23/10; H01J 25/02

(52) U.S. Cl. CPC G21B 1/23; H01J 23/027; H01J 23/065; H01J 23/10; H01J 25/02

(57) ABSTRACT

An apparatus is configured to generate electromagnetic radiation having a frequency component between 10 GHz to 10 THz, the apparatus includes an electron source that produces an electron beam. The apparatus further includes a magnetic field generator that produces a magnetic field to condition and guide the electron beam within interaction region where electromagnetic radiation is generated. The apparatus further includes waveguide having cylindrical structure. The cylindrical structure is coaxially aligned with electron beam in the interaction region. An inner surface of the cylindrical structure is configured to facilitate a Cherenkov interaction between the electron beam and an electromagnetic field excited and supported inside the waveguide to generate the electromagnetic radiation. The apparatus further includes an output coupler configured to output the electromagnetic radiation from the apparatus. The apparatus further includes an electron beam collector configured to collect the electron beam and recuperate energy from the electron beam after the interaction region.

### TECHNICAL FIELD OF THE INVENTION

The invention relates to generating electromagnetic radiation for use, particularly but not exclusively, in high power applications such as plasma heating in fusion reaction systems, remote monitoring of environment and quality assessment of large areas composite materials.

### BACKGROUND OF THE INVENTION

Gyrotrons provide a continuous wave (CW) source of electromagnetic (EM) radiation for use in high power applications such as plasma heating in fusion reaction systems. Such gyrotrons may be capable of delivering between 0.5 MW to 2 MW of output power in a frequency range between 70 GHz to 300 GHz (where higher power is associated with a lower frequency). Gyrotrons have demonstrated in experiments an efficiency of up to 50% for the lower frequencies. Other sources of EM radiation such as a backward wave oscillator (BWO) and travelling wave tube (TWT) may be capable of reaching an efficiency above 70%. However, the output power of a BWO or TWT may not exceed 1 kW, which is not sufficient for high power applications.

To reach higher efficiencies, a multi-stage depressed collector (MDC) may be used to recuperate energy from the system. Gyrotrons are not known to achieve an efficiency above 55% due to the need to extract energy from circular motion of the spiralling electron beam (i.e., electron beam spiral trajectories). The circular motion of the spiralling electron beam is used to support electron beam—EM wave interaction with the transverse electric (TE) mode of the gyrotron cavity. To reach high efficiency (around 30%-40%) in microwave generation, the electron beam in a high-power gyrotron has more than 50% of its energy in circular motion, which limits the capability of the energy recuperation stage to improve further the efficiency above 55%. BWOs/TWTs are driven by a laminar flow electron beam with 90% energy of the beam in translational motion, which allows to generate microwave radiation and extract energy from the spent beam efficiently (up to 80%) using the MDC. BWO/TWTs cannot reach the MW powers (required for fusion) as, in order to suppress the excitation of the parasitic modes, the interaction region transverse dimension (for example diameter) is of the order of the interaction wavelength, thus limiting the power generated by the source. An increase of the interaction region diameter is expected to lead to the termination of the stable, steady state, single mode operation of the radiation source.

### SUMMARY OF THE INVENTION

As noted above, there are limitations with existing technologies for producing EM radiation for use in high power applications such as plasma heating in fusion reaction systems and other high-power applications. It would thus be valuable to have an improvement aimed at addressing these limitations.

Therefore, according to a first aspect of this disclosure, there is provided apparatus configured to generate electromagnetic radiation comprising a frequency component in a frequency range of 10 GHz to 10 THz. The apparatus comprises an electron source configured to produce an electron beam. The apparatus further comprises a magnetic field generator configured to produce a magnetic field to condition and guide the electron beam within an interaction region where the electromagnetic radiation is generated. The apparatus further comprises a waveguide comprising a cylindrical structure. The cylindrical structure is coaxially aligned with the electron beam in the interaction region. An inner surface of the cylindrical structure is configured to facilitate a Cherenkov interaction between the electron beam and an electromagnetic field excited and supported inside the waveguide to generate the electromagnetic radiation. The apparatus further comprises an output coupler configured to output the electromagnetic radiation from the apparatus. The apparatus further comprises an electron beam collector configured to collect the electron beam and recuperate energy from the electron beam after the interaction region.

According to a second aspect of this disclosure, there is provided a method of generating electromagnetic radiation comprising a frequency component in a frequency range of 10 GHz to 10 THz. The method comprises producing an electron beam. The method further comprises producing a magnetic field to condition and guide the electron beam within an interaction region where the electromagnetic radiation is generated. The method further comprises using a waveguide comprising a cylindrical structure to facilitate a Cherenkov interaction between the electron beam and an electromagnetic field excited and supported inside the waveguide to generate the electromagnetic radiation. The cylindrical structure is coaxially aligned with the electron beam in the interaction region. The method further comprises outputting the electromagnetic radiation. The method further comprises collecting the electron beam after the interaction region to recuperate energy from the electron beam.

According to a third aspect of this disclosure, there is provided a fusion reaction system. The fusion reaction system comprises a chamber configured to confine a plasma. The fusion reaction system further comprises the apparatus according to the first aspect or any related embodiment. The electromagnetic radiation output by the apparatus is configured to heat the plasma.

According to a fourth aspect of this disclosure, there is provided a waveguide for an apparatus configured to generate electromagnetic radiation comprising a frequency component in a frequency range of 10 GHz to 10 THz. The waveguide comprises a cylindrical structure. An inner surface of the cylindrical structure is configured to facilitate a Cherenkov interaction between an electron beam generated by the apparatus and an electromagnetic field excited and supported inside the waveguide to generate the electromagnetic radiation. The cylindrical structure is to be coaxially aligned with the electron beam in an interaction region of a magnetic field for conditioning and guiding the electron beam where the electromagnetic radiation is to be generated. A diameter, D, of the cylindrical structure meets a condition, D/λ>3, where 2 is a wavelength related to the frequency component.

According to the aspects described above and embodiments described below, the limitations of existing techniques are addressed. In particular, more efficient generation (e.g., around 80% but not limited thereto) of coherent high power (e.g., in the range 0.5MW-2MW but not limited thereto) EM radiation is possible as compared with the gyrotron technology. There is thus provided an improved apparatus and method for generating EM radiation, an improved waveguide for facilitating the generation of EM radiation using such apparatus and an improved fusion reaction system.

These and other aspects of the invention will be apparent from and elucidated with reference to the embodiment(s) described hereinafter.

### BRIEF DESCRIPTION OF DRAWINGS

Exemplary embodiments of the invention will now be described, by way of example only, with reference to the following drawings, in which:

FIG. 1 is a schematic drawing of apparatus configured to generate electromagnetic radiation according to an embodiment;

FIG. 2 is a schematic drawing of a waveguide for use in the apparatus according to an embodiment;

FIG. 3 is a schematic drawing of a fusion reaction system according to an embodiment; and

FIG. 4 refers to a method of generating electromagnetic radiation according to an embodiment.

### DETAILED DESCRIPTION OF THE EMBODIMENTS

As highlighted above, although certain technologies such as BWOs/TWTs exist for high efficiency EM radiation generation (e.g., in a frequency range between 70 GHZ to 300 GHz), such technologies cannot generate EM radiation with an output power suitable for high power applications such as plasma heating in fusion reaction systems or operate at higher frequencies (e.g., above 300 GHz) generating sufficient (e.g., above 10 W) output power. Therefore, other technologies such as gyrotrons have been adopted for such high-power applications.

In order for nuclear fusion to become commercially viable, the power output of a fusion reaction system should exceed the energy input to the system. The energy input involves heating a plasma to a sufficiently high temperature to trigger the fusion reaction.

Any improvement of energy efficiency that can be made in any part of the fusion reaction system, no matter how small that improvement is, could be instrumental in creating a commercially viable fusion reaction system. With an efficiency of up to 55%, gyrotrons are relatively inefficient at generating EM radiation compared with other technologies.

Therefore, an improvement is needed.

FIG. 1 is a schematic drawing of apparatus 100 configured to generate electromagnetic (EM) radiation 102 according to an embodiment. The generated EM radiation 102 comprises a frequency component in a frequency range of 10 GHz to 10 THz.

The apparatus 100 comprises an electron source 104 (such as an electron gun) configured to produce an electron beam 106. As explained in more detail herein, the electron source 104 is configured to produce the electron beam 106 in a form that is suitable for being conditioned and guided in the apparatus 100. Although not specifically depicted by FIG. 1, the electron source 104 may include a set of components to facilitate production of the electron beam 106. For example, the electron source 104 may comprise an electron gun for producing the electron beam 106.

The apparatus 100 further comprises a magnetic field generator 108 configured to produce a magnetic field to condition and guide the electron beam 106 within an interaction region where the EM radiation 102 is generated. One or more magnetic field generators 108 (e.g., coils) may be included as part of the apparatus 100 in order to provide the conditioning and guiding functionality. The electron beam 106 may need to be conditioned by being compressed, shaped and/or “cooled-down” (meaning changing the beam shape in 6-dimensional (velocity, space) parametric space, as described in more detail below) using the magnetic field generator 108. Such conditioning may prepare the electron beam for better interactions with electromagnetic fields within the apparatus 100. The term “guiding” as used herein refers to driving the electron beam 106.

The magnetic field generator 108 may comprise a cryogenically cooled electromagnet system or cryogen-free magnet system such as may be implemented by a gyrotron. The function of the magnetic field generated by the magnetic field generator 108 may be different to the function of the magnetic field generated in a gyrotron. For example, in a gyrotron, the magnetic field functions to drive and tune the spiraling electron beam to the operating mode and frequency of the gyrotron. In the apparatus 100, the magnetic field functions to drive the electron beam 106 and facilitate interaction between the electron beam 106 and other components of the apparatus 100, as described in more detail below.

As used herein, the term “interaction region” refers to the section of the apparatus 100 where the EM radiation 102 is generated as a result of an interaction described in more detail below.

The apparatus 100 further comprises a waveguide 110. The waveguide 110 comprises a cylindrical structure. The cylindrical structure is coaxially aligned with the electron beam 106 in the interaction region. An inner surface of the cylindrical structure is configured to facilitate a Cherenkov interaction between the electron beam 106 and an electromagnetic field excited and supported inside the waveguide 110 to generate the electromagnetic radiation 102.

The physics of the generation of the EM radiation 102 by the apparatus 100 is different to that of the gyrotron. Instead of being a cyclotron-type interaction where a spiraling electron beam emits EM radiation, as in a gyrotron, the interaction is instead a Cherenkov interaction.

In a Cherenkov-type interaction, EM radiation 102 is generated as a result of the electron beam 106 being decelerated due to the effect of the electromagnetic field excited and supported inside the waveguide 110. It is not necessary to use a spiraling electron beam when relying on the Cherenkov-type interaction and other types of electron beam may be used, as described in more detail below.

The resonance may be very sharp in the high-Q cavity (defined by the interaction region) of the apparatus 100 such that the conditioning (as referred to previously) may be needed to bring the electron beam 106 to the resonance condition, which depends explicitly on the electron beam 106 longitudinal velocity (i.e., the Cherenkov interaction).

During the conditioning, a transformation of the electron beam 106 shape and longitudinal and transverse velocities (e.g., increase the transverse and reduce longitudinal velocity, or make any other appropriate changes) may be needed to tune the electron beam 106 to the resonance.

The cylindrical structure may have an appropriate configuration to facilitate the Cherenkov interaction, as described in more detail below.

The apparatus 100 further comprises an output coupler 112 configured to output the electromagnetic radiation 102 from the apparatus 100. For example, the output coupler 112 may comprise a reflector configured to reflect at the operating wavelength of the apparatus 100. The output coupler 112, specific for a specific operating mode, may be positioned to reflect the EM radiation 102 while also allowing the electron beam 106 to pass through to a latter section of the apparatus 100. For example, the reflector may be an annulus which allows the electron beam 106 to pass through its center and reflect the annular beam profile of the EM radiation 102. Another configuration of the reflector can be Vlasov type mode converter. The design and position of the output coupler 112 may depend on various parameters such as the beam profile of the electron beam 106, operating mode structure, as well as any other parameters that may affect the beam profile of the EM radiation 102.

The apparatus 100 further comprises an electron beam collector 114 configured to collect the electron beam 106 and recuperate energy from the electron beam 106 after the interaction region. For example, the electron beam collector 114 may comprise a depressed collector such as a multi-stage depressed collector (MDC). The electron beam collector 114 may recover energy (via circuitry, not shown) from the electron beam 106 after the electron beam 106 has passed through the interaction region. The amount of energy recuperated from the electron beam 106 plays a role in determining the energy efficiency of the apparatus 100, since any energy recuperated may be used to decrease energy input to the apparatus 100 in order to generate a given EM radiation 102 power.

Thus, while there are similarities between the apparatus 100 and a gyrotron, there are some differences. The EM radiation 102 generated by the apparatus 100 is based on the Cherenkov interaction with the electron beam 106 instead of a cyclotron interaction, as in the gyrotron. One of the differences between the apparatus 100 and a gyrotron involves the provision of the waveguide 110 in the interaction region.

Interest in generating EM radiation for high power applications based on the Cherenkov-type interaction has been limited due to the relatively low efficiencies that are possible with this technology. For example, an efficiency of up to 20-30% at lower frequencies and up to 10% at higher frequencies may be possible using technology based on the Cherenkov-type interaction. Thus, the trend in the art has been to use gyrotrons for high power applications and other devices such as BWOs and TWTs for low power applications.

However, this disclosure identifies the possibility to gain a higher-than-expected energy efficiency improvement by making use of such a Cherenkov-type interaction.

As noted previously, there is a limit on the energy efficiency obtainable with a gyrotron (e.g., up to 55%). A significant reason for this limit is due to the characteristics of the electron beam in gyrotrons and the design of the electron beam collector (such as a multistage depressed collector). The energy from the spiraling motion of the electron beam in a gyrotron is relatively difficult to recover, which places a practical limit on the level of energy recuperation that is possible with an MDC coupled to a gyrotron.

However, the apparatus 100 does not need to make as much use of such a spiraling electron beam due to the different type of interaction to generate the EM radiation 102, which opens up the possibility to use a more efficient electron beam collector. This disclosure identifies that the energy recovery is higher (for example, above 55%, and potentially greater than 60%) when employing the Cherenkov-type interaction facilitated by the waveguide 110 alongside the more efficient electron beam collector that can be used when not rely so much on a spiraling electron beam. Such a combination of waveguide 110 and electron beam collector 114 has not been contemplated previously due to the belief in the art that Cherenkov-type interactions tend to yield insufficient efficiencies for high power applications.

The apparatus 100 and related embodiments may therefore allow to increase the overall efficiency of a source of EM radiation 102 in the range 10 GHz to 10 THz while making the operation of the source more stable and robust. The design of the apparatus 100 is such that the components can be supplied in modular way, making the production and service cheaper. Thus, the apparatus 100 may: help to reduce the cost of manufacturing and service running (cost); increase the total efficiency to above 60% and, as a result, reduce the amount of the input energy required to sustain a fusion reaction; and/or have an improved reliability since the apparatus 100 may be less sensitive to external environment.

Some embodiments relating the apparatus 100 are now described.

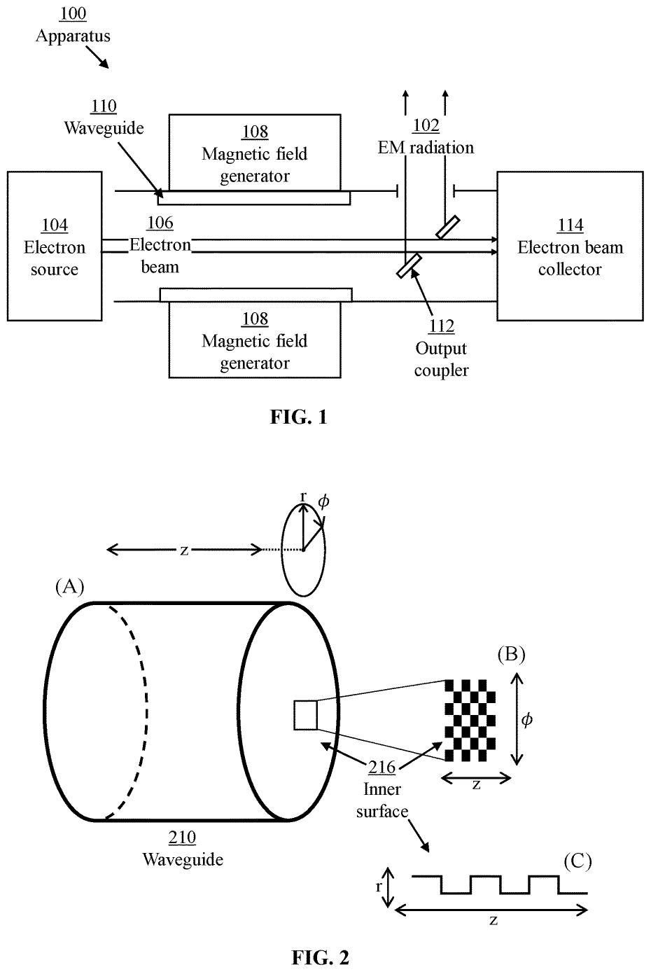

FIG. 2 is a schematic drawing of a waveguide 210 for use in apparatus such as the apparatus 100, to which reference is made in the following description. As referred to previously, the role of the waveguide 210 is to facilitate the Cherenkov type interaction. In this manner, the waveguide 210 forms a cavity (i.e., a resonator) in which the generation of the EM radiation 102 takes place. The electron beam 106 is decelerated in the field inside the cavity and thus electromagnetic radiation is generated based on the Cherenkov principle. For the efficient interaction between the EM field inside the cavity and electron beam 106, there is no need to pump a transverse (i.e., circular) motion electron beam such that most of the energy in the electron beam 106 is in a translational (i.e., longitudinal) direction. After interaction in the interaction region, the electron beam propagates to the electron beam collector 114 where the more efficient energy recuperation can take place.

FIG. 2(A) depicts the cylindrical structure of the waveguide 210. A coordinate system is established to aid with explanation of the structural features of the waveguide 210. The longitudinal direction refers to the z-axis. The azimuthal direction is specified by the azimuthal coordinate φ, which defines the angular measurement in a given radial direction from the longitudinal axis of the cylindrical structure. The radius r refers to the distance from the origin/center of the cylindrical structure (defined by the longitudinal axis) to an inner surface 216 of the waveguide 210. When integrated with the apparatus 100, the cylindrical structure is coaxial with the propagation axis of the electron beam 106, which passes through the hollow part of the cylindrical structure.

An inner surface 216 of the waveguide 210 is configured to facilitate the Cherenkov-type interaction and allow a high-order mode selection that has a large diameter. High-order modes are those modes which have large number of either radial or azimuthal variations i.e., given for example by E_{m,n} where m (and/or) n are significantly larger than 1, i.e. m(n)>>1. By way of example, in the case of a waveguide 210 with mean diameter, D, and operating wavelength, λ, meeting the condition D/λ>3, the number of azimuthal variations may be m≥5 and/or n≥5. Further, the waveguide 210 is configured to support the interaction of the electron beam 106 flow with the EM field (i.e., an eigenmode of the cavity) that is excited and supported due to the design of the waveguide 210. The waveguide 210 (cavity) may be considered to be a surface field cavity since surface EM fields are induced in the waveguide 210 as a result of the interaction between the electron beam 106 and the waveguide 210, which functions to decelerate the electron beam 106 and thereby radiate the EM radiation 102.

The waveguide 210 may comprise a metal (e.g., copper, silver, etc.) or composite cylindrical structure (comprising a highly conductive material such as metal alongside a low conductive material to provide support to the highly conductive material) with periodic perturbations along both the longitudinal (along propagation electron beam) and azimuthal directions. The periodic perturbations are designed to suppress electron motion inside conductive material in certain directions and thereby increase the impedance of the waveguide 210 compared with a cylindrical structure without such perturbations. These periodic perturbations are such that the radius, r, varies depending on the longitudinal and azimuthal coordinates. These periodic perturbations may restrict free electrons motion (in other words, increase the impedance) in both the longitudinal and azimuthal directions, which results in excitation of a specific cavity eigenmode (field) inside waveguide 210 which acting on the electron beam 106 leads to deceleration of the electron beam 106 and corresponding generation of the EM radiation 102.

Thus, in some embodiments, the inner surface 216 comprises a two-dimensional periodic structure configured such that a radial distance, r, between a longitudinal axis of the cylindrical structure and a position on the inner surface 216 varies depending on both a longitudinal coordinate and an azimuthal coordinate of the position on the inner surface. An example (not limited to) of such a two-dimensional periodic structure is depicted by FIG. 2(B), which depicts a chessboard-like pattern on the inner surface 216. The chessboard-like pattern represents the two-dimensional periodic structure. FIG. 2(C) represents a cross-section of the two-dimensional periodic structure depicted by FIG. 2(B). FIG. 2(C) does not depict the curvature of the cylindrical structure. It is therefore apparent that the inner surface 216 includes a series of periodic perturbations in its surface structure in two dimensions. FIG. 2 depicts a rectangular-type periodic structure with two possible levels (e.g., heights) with respect to the average radius of the cylindrical structure.

Thus, in some embodiments, the inner surface 216 has a periodic surface height variation that varies in two dimensions along the inner surface 216.

Other types of two-dimensional periodic structures such as based on a sinusoidal (e.g., undulating) structure may be used in the waveguide 210. For example, a radius, r, of the inner surface 216 may be defined by the expression r=r₀+r₁ cos(k̅_̅{̅z̅}̅z) cos(m̅φ), where r₀ is a mean radius of the cylindrical structure, r₁ is an amplitude of surface height variations of the two-dimensional periodic structure, z is the longitudinal coordinate, k̅_̅{̅z̅}̅=2π/p_{z}, p_{z} is a longitudinal period of the two-dimensional periodic structure, m is a number of azimuthal variations of the two-dimensional periodic structure, and φ is the azimuthal coordinate.

In some cases, the cylindrical structure could be manufactured by machining a surface of a metal plate with any two-dimensional periodic structure such as described above and then rolling the plate into the cylindrical structure with the machined surface on the inside of the cylindrical structure.

The amplitude/depth of the surface heigh variations/perturbations may be in the range 0.1 to 10 operating wavelengths of the apparatus 100 to allow electromagnetic waves to form the field inside the cylindrical structure. Thus, in some embodiments, the surface height variation has an amplitude in a range of 0.1 to 10 operating wavelengths of the apparatus 100. The operating wavelength λ is related to the frequency component ƒ e.g., via the expression c=∂λ, where c is the speed of light.

In some embodiments, the inner surface 216 comprises a conductor such as a metal and the inner surface 216 is structured to increase an impedance of the waveguide 210 in both a longitudinal and azimuthal direction along the cylindrical structure. The two-dimensional periodic structures described above are examples of structures that increase the impedance of the waveguide 210.

The transverse dimensions of the cavity, for example diameter D, may be identified with respect to the operating wavelength λ which can be in the range 3 cm (centimeters) to 30 μm (micrometers). The diameter D can be in the range D/λ=3 . . . 1000, which may allow a low power density to be maintained to support continuous wave (CW) high power operation of the apparatus 100 in the output power range of 0.1 MW to 10 MW in a reliable manner. Increasing the interaction region diameter without adding the waveguide 210 may lead to termination of the stable single mode operation. Thus, the additional of the waveguide 210 may help to support stable single mode operation with high power output and low power density.

Thus, in some embodiments, a diameter, D, of the cylindrical structure meets a condition, D/λ>3 where λ is an operating wavelength of the apparatus. That is, the condition is that the ratio of the diameter, D, to operating wavelength, λ, is greater than three. The operating wavelength is related to the frequency component. The diameter may refer to the mean diameter of the cylindrical structure. Such a parameter relation of D/λ>3 has not been used previously. Other parameter relations are possible such as D/λ4, 4.1, . . . , 5, 5.1, . . . 10, . . . , 1000.

In some embodiments, the apparatus 100 is configured to output electromagnetic radiation 102 at an average power that exceeds: 250 kW in a frequency range of 10 GHz to 300 GHz; 1 kW in a frequency range of 300 GHz to 1 THz; and/or 100 W in a frequency range above 1 THz. Using the waveguide 210 as described previously facilitates such high-power operation at the specified frequency ranges.

In some embodiments, the apparatus 100 is configured to output continuous wave electromagnetic radiation 102.

In some embodiments, the apparatus 100 is configured to output pulsed wave electromagnetic radiation 102.

In some embodiments, the apparatus is for heating plasma in a fusion reaction system. In some embodiments, the apparatus is for use in large area surveillance and environment monitoring. In some embodiments, the apparatus is for use in quality assessment of large areas of composite materials.

In some embodiments, the electron beam 106 has most of its energy in laminar (e.g., linear flow).

Where the electron beam 106 is in the interaction region, the electron beam profile may be annular, as in the case of gyrotrons. However, a majority proportion of overall energy of the electron beam is in the translational direction rather than the circular (transverse) direction. Thus, in some embodiments, the electron beam has above 75% of its energy in laminar flow and less than 25% of its energy in circular motion. As noted previously, it may be easier to recuperate energy from a laminar flow electron beam than a spiraling electron beam. By providing more energy in the laminar flow proportion of the electron beam, the overall energy efficiency may be increased due to the greater amount of energy recuperation possible from such electrons.

FIG. 3 is a schematic drawing of a fusion reaction system 320 according to an embodiment. The fusion reaction system 320 comprises a chamber 322 configured to confine a plasma (such as based on a Tokamak design or any other appropriate design). The fusion reaction system 320 further comprises an apparatus 300 (e.g., with the same features of the apparatus 100 of FIG. 1 or any related embodiment). The EM radiation output by the apparatus is configured to heat the plasma. In this regard, the apparatus 300 is operatively coupled to the chamber 322 in order for the chamber 322 to receive the EM radiation.

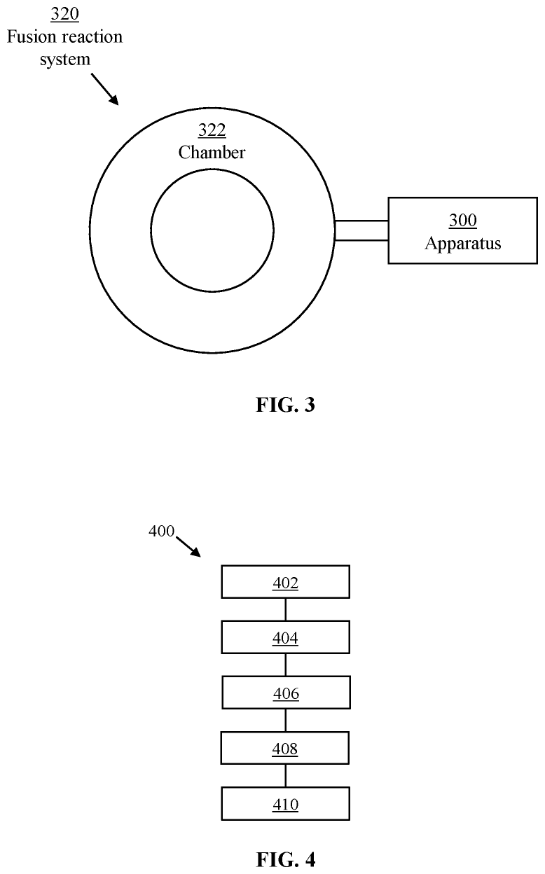

FIG. 4 refers to a method 400 of generating electromagnetic radiation according to an embodiment. The generated electromagnetic radiation comprises a frequency component in a frequency range of 10 GHz to 10 THz. Reference is made to FIG. 1 in the following description.

The method 400 comprises, at block 402, producing an electron beam 106;

The method 400 further comprises, at block 404, producing a magnetic field to guide the electron beam 106 within an interaction region where the electromagnetic radiation 102 is generated.

The method 400 further comprises, at block 406, using a waveguide 110 comprising a cylindrical structure to facilitate a Cherenkov interaction between the electron beam 106 and an electromagnetic field excited and supported inside the waveguide 110 to generate the electromagnetic radiation 102. The cylindrical structure is coaxially aligned with the electron beam 106 in the interaction region;

The method 400 further comprises, at block 408, outputting the electromagnetic radiation 102.

The method 400 further comprises, at block 410, collecting the electron beam 106 after the interaction region to recuperate energy from the electron beam 106.

While the invention has been illustrated and described in detail in the drawings and foregoing description, such illustration and description are to be considered illustrative or exemplary and not restrictive; the invention is not limited to the disclosed embodiments.

One or more features described in one embodiment may be combined with or replace features described in another embodiment.

Elements or steps described in relation to one embodiment may be combined with or replaced by elements or steps described in relation to another embodiment. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. Any reference signs in the claims should not be construed as limiting the scope.

1. An apparatus configured to generate electromagnetic radiation comprising a frequency component in a frequency range of 10 GHz to 10 THz, the apparatus comprising:
an electron source configured to produce an electron beam
a magnetic field generator configured to produce a magnetic field to condition and guide the electron beam within an interaction region where the electromagnetic radiation is generated;
a waveguide comprising a cylindrical structure, wherein the cylindrical structure is coaxially aligned with the electron beam in the interaction region, and wherein an inner surface of the cylindrical structure is configured to facilitate a Cherenkov interaction between the electron beam and an electromagnetic field excited and supported inside the waveguide to generate the electromagnetic radiation;
an output coupler configured to output the electromagnetic radiation from the apparatus; and
an electron beam collector configured to collect the electron beam and recuperate energy from the electron beam after the interaction region.

2. The apparatus of claim 1, wherein the inner surface comprises a two-dimensional periodic structure configured such that a radial distance between a longitudinal axis of the cylindrical structure and a position on the inner surface varies depending on both a longitudinal coordinate and an azimuthal coordinate of the position on the inner surface.

3. The apparatus of claim 1, wherein the inner surface has a periodic surface height variation that varies in two dimensions along the inner surface.

4. The apparatus of claim 3, wherein the surface height variation has an amplitude in a range of 0.1 to 10 operating wavelengths of the apparatus, wherein the operating wavelength is related to the frequency component.

5. The apparatus of claim 1, wherein the inner surface comprises a conductor, and wherein the inner surface is structured to increase an impedance of the waveguide in both a longitudinal and azimuthal direction along the cylindrical structure.

6. The apparatus of claim 1, wherein a diameter, D, of the cylindrical structure meets a condition, D/λ>3, where λ is an operating wavelength of the apparatus, wherein the operating wavelength is related to the frequency component.

7. The apparatus of claim 1, wherein the apparatus is configured to output electromagnetic radiation at an average power that exceeds:
250 kW in a frequency range of 10 GHz to 300 GHz;
1 kW in a frequency range of 300 GHz to 1 THz; and/or
100 W in a frequency range above 1 THz.

8. The apparatus of claim 1, wherein the apparatus is configured to output continuous or pulsed wave electromagnetic radiation.

9. The apparatus of claim 1, wherein the apparatus is for heating plasma in a fusion reaction system.

10. The apparatus of claim 1, wherein the electron beam has most of its energy in laminar flow.

11. The apparatus of claim 10, wherein the electron beam has above 75% of its energy in laminar flow and less than 25% of its energy in circular motion.

12. A fusion reaction system comprising:
a chamber configured to confine a plasma; and
the apparatus of claim 1, wherein the electromagnetic radiation output by the apparatus is configured to heat the plasma.

13. A method of generating electromagnetic radiation comprising a frequency component in a frequency range of 10 GHz to 10 THz, the method comprising:
producing an electron beam;
producing a magnetic field to condition and guide the electron beam within an interaction region where the electromagnetic radiation is generated;
using a waveguide comprising a cylindrical structure to facilitate a Cherenkov interaction between the electron beam and an electromagnetic field excited and supported inside the waveguide to generate the electromagnetic radiation, wherein the cylindrical structure is coaxially aligned with the electron beam in the interaction region;
outputting the electromagnetic radiation; and
collecting the electron beam after the interaction region to recuperate energy from the electron beam.

14. A waveguide for an apparatus configured to generate electromagnetic radiation comprising a frequency component in a frequency range of 10 GHz to 10 THz, wherein the waveguide comprises a cylindrical structure, wherein an inner surface of the cylindrical structure is configured to facilitate a Cherenkov interaction between an electron beam generated by the apparatus and an electromagnetic field excited and supported inside the waveguide to generate the electromagnetic radiation, wherein the cylindrical structure is to be coaxially aligned with the electron beam in an interaction region of a magnetic field for conditioning and guiding the electron beam where the electromagnetic radiation is to be generated, wherein a diameter, D, of the cylindrical structure meets a condition, D/λ>3, where λ is a wavelength related to the frequency component.

15. The waveguide of claim 14, wherein the inner surface comprises a two-dimensional periodic structure configured such that a radial distance between a longitudinal axis of the cylindrical structure and a position on the inner surface varies depending on both a longitudinal and azimuthal coordinate of the position on the inner surface.

16. The waveguide of claim 14, wherein the inner surface has a periodic surface height variation that varies in two dimensions along the inner surface.

17. The waveguide of claim 14, wherein the inner surface comprises a conductor, and wherein the inner surface is structured to increase an impedance of the waveguide in both a longitudinal and azimuthal direction along the cylindrical structure.
